(19) United States
(12) Patent Application Publication
(10) Pub. No.: US 2007/0074025 A1
(43) Pub. Date: Mar. 29, 2007

(54) Battery pack, portable electronic apparatus, and control method thereof

(75) Inventors: Young-ho Baek, Daegu (KR); Kang-seok Cho, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/523,013

(22) Filed: Sep. 19, 2006

(30) Foreign Application Priority Data
Sep. 28, 2005 (KR) 2005-90649

(51) Int. Cl. H04L 9/00

(52) U.S. Cl. 713/172

(57) ABSTRACT

Disclosed are a battery pack having a dummy battery function, a portable electronic apparatus and a control method thereof. The portable electronic apparatus, includes a system body connectable to a plurality of components; a battery to supply power to the system body; a battery charging part to charge the battery with power externally supplied; a user selecting part selectable between a dummy mode and a normal mode related to the battery; and a controller to control the battery charging part to not charge the battery when the dummy mode is selected through the user selecting part and control the battery charging part to charge the battery when the normal mode is selected through the user selecting part. With this configuration, a dummy battery function is provided avoid the performance of a battery from deterioration and the durability of the battery from being reduced.

### CROSS-REFERENCE TO RELATED APPLICATION

This application claims the benefit of Korean Application No. 2005-90649, filed Sep. 28, 2005 in the Korean Intellectual Property Office, the disclosure of which is incorporated herein by reference.

### BACKGROUND OF THE INVENTION

1. Field of the Invention

Aspects of the present invention relate to a battery pack, a portable electronic apparatus and a control method thereof, and more particularly, to a battery pack having a dummy battery function, a portable electronic apparatus and a control method thereof.

2. Description of the Related Art

In general, electronic apparatuses equipped with batteries have been widely used due to their portability and mobility. Examples include portable computers such as laptop computers, notebook computers, Personal Digital Assistants(PDA), or the like, CD players, video camcorders, etc., There are many cases where such portable electronic apparatuses use a battery and an adapter simultaneously. When the battery and the adapter are simultaneously used, the battery may be, in many cases, maintained at a charged rate of 100%. In addition, even when the portable electronic apparatuses use only the battery, there are many cases where the adapter may be used for a short time after the battery is used rather than having the exhausted battery recharged and reused.

However, if the battery is used without a complete discharging and charging, a problem of reduced durability of the battery and deteriorated performance of the battery due to a memory effect may arise. In order to overcome such a problem, the adapter may be used with the battery detached, or a dummy battery (i.e., an imitation battery with no battery function), may be purchased and used separately in consideration of external appearance of the electronic apparatus.

### SUMMARY OF THE INVENTION

Accordingly, it is an aspect of the present invention to provide a battery pack having a dummy battery function for preventing the performance of a battery from being deteriorated and the durability of the battery from being reduced for a portable computer and a control method thereof.

Aspects of the present invention can be achieved by providing a portable electronic apparatus, including: a system body connectable to a plurality of components a battery to supply power to the system body; a battery charging part to charge the battery with power externally supplied; a user selecting part selectable between a dummy mode and a normal mode related to the battery; and a controller to control the battery charging part to release charging of the battery if the dummy mode is selected through the user selecting part and control the battery charging part to charge the battery when the normal mode is selected through the user selecting part.

According to an aspect of the invention, the portable electronic apparatus further includes a memory in which mode information related to the dummy mode and the normal mode is set, wherein the controller sets the mode information based upon the mode selected through the user selecting part in the memory.

According to an aspect of the invention, wherein the controller controls the battery charging part to charge the battery based on the mode information set in the memory.

According to an aspect of the invention, the user selecting part is provided in the battery, and the controller includes a battery controller provided in the battery to provide the mode information corresponding to the selection of the user selecting part to the system body, and a body controller to control the battery charging part to charge the battery based on the mode information provided from the battery controller.

According to an aspect of the invention, the battery includes a memory in which information related to the dummy mode and the normal mode is stored, and the battery controller stores the mode information on the mode selected through the user selecting part in the memory.

According to an aspect of the invention, the battery controller communicates with the body controller via a system management (SM) bus.

According to an aspect of the invention, the user selecting part includes a first user selecting part provided in the battery and a second user selecting part provided in the system body.

According to an aspect of the invention, the memory includes a first memory in which first mode information corresponding to selection of the first user selecting part is stored and the system body includes a second memory in which second mode information corresponding to selection of the second user selecting part is stored, wherein the controller includes a battery controller provided in the battery to store the first mode information in the first memory, and a body controller to store the second mode information in the second memory.

According to an aspect of the invention, the battery controller provides the first mode information to the system body, and the body controller controls the battery charging part to charge the battery based on the first mode information provided from the battery controller and the second mode information from the second memory.

According to an aspect of the invention, the body controller controls the battery charging part to not charge the battery when at least one of the first mode information and the second mode information is related to the dummy mode.

Another aspects of the present invention can be achieved by providing a battery pack mounted in an electronic apparatus for supplying power to the electronic apparatus, including: a battery; a user selecting part selectable between a dummy mode and a normal mode related to the battery; a memory in which mode information related to the dummy mode and the normal mode is stored; and a battery controller to set the mode information on the mode selected through the user selecting part in the memory and transmit the set mode information to the electronic apparatus.

Aspects of the present invention can be achieved by providing a portable electronic apparatus, including: a battery connector to which a battery is connected; a system body connectable to a plurality of components driven by power supplied from the battery; a battery charging part to charge the battery with power externally supplied; a user selecting part selectable between a dummy mode and a normal mode related to the battery; and a controller to control the battery charging part to not charge the battery when the dummy mode is selected through the user selecting part and control the battery charging part to charge the battery when the normal mode is selected through the user selecting part.

According to an aspect of the invention, the portable electronic apparatus further includes a memory in which mode information related to the dummy mode and the normal mode is set, and the controller sets the mode information based upon the mode selected through the user selecting part in the memory and controls the battery charging part to charge the battery based on the mode information set in the memory.

According to an aspect of the invention, the controller controls the battery charging part to not charge the battery, based on first mode information provided from the battery and second mode information stored in the memory, when at least one of the first mode information and the second mode information is related to the dummy mode.

Aspects of the present invention can be achieved by providing a control method of a portable electronic apparatus having a system body having a plurality of components, a battery to supply power to the system body, a battery charging part to charge the battery with power externally supplied, and a user selecting part, the control method including: selecting one of a dummy mode and a normal mode related to the battery through the user selecting part, the user selecting part allowing a selection selectable between dummy and normal modes; and controlling the battery charging part to not charge the battery when the dummy mode is selected through the user selecting part, and controlling the battery charging part to charge the battery when the normal mode is selected through the user selecting part.

According to an aspect of the invention, the controlling the battery charging part includes setting mode information based upon the mode selected through the user selecting part in a predetermined memory and controlling the battery charging part to charge the battery or release charging of the battery based on the mode information set in the memory.

According to an aspect of the invention, the user selecting part is provided in the battery, and the controlling the battery charging part includes providing mode information corresponding to selection of the user selecting part to the system body and controlling the battery charging part to charge the battery or not charge the battery based on the mode information.

According to an aspect of the invention, the battery further includes a memory in which the mode information related to the dummy mode and the normal mode is set, and the providing the mode information corresponding to selection of the user selecting part to the system body includes setting the mode information in the memory in correspondence with selection of the user selecting part and transmitting the mode information set in the memory to the system body.

According to an aspect of the invention, the user selecting part includes a first user selecting part provided in the battery and a second user selecting part provided in the system body; the memory includes a first memory in which first mode information corresponding to selection of the first user selecting part is stored and the system body includes a second memory in which second mode information corresponding to selection of the second user selecting part is stored; and the controlling the battery charging part includes storing the first mode information in the first memory, storing the second mode information in the second memory, providing the first mode information to the system body, and controlling the battery charging part to charge the battery or not charge the battery based on the first mode information and the second mode information.

According to an aspect of the invention, the controlling the battery charging part to charge the battery or not charge the battery includes controlling the battery charging part to release charging of the battery when at least one of the first mode information and the second mode information is related to the dummy mode.

According to another aspect of the present invention, a portable device includes: a battery having a first selector; a main body having a second selector and a controller, wherein the controller disables the battery when either of the first or second selectors is set to a disable mode.

According to another aspect of the present invention, a method of controlling a portable device having a battery having a first selector and a main body having a second selector, including disabling a charging of the battery when either of the first or second disable selectors is set to a disable mode.

According to another aspect of the present invention, a battery pack for a portable device, including: a cell to supply power; a controller to control charging of the cell according to selection states selectable between a dummy mode and a normal mode; and a memory storing the selection states used by the controller.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 is a control block diagram of a portable computer according to an aspect of the present invention;

FIG. 2 is a control flow chart of the portable computer according to an aspect of the present invention; and

FIG. 3 is a control flow chart of a portable computer according to an aspect of the present invention.

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

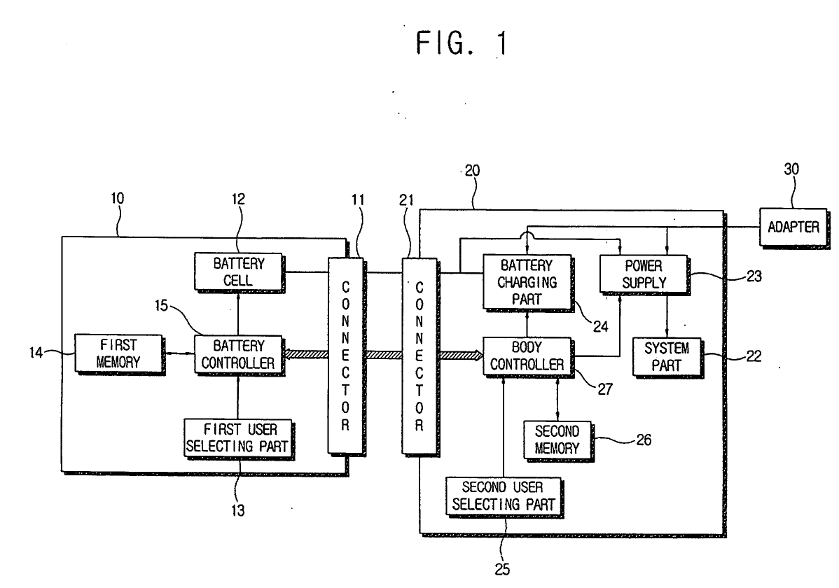

FIG. 1 is a control block diagram of a portable computer according to an aspect of the present invention. As shown in FIG. 1, the portable computer includes a battery 10 and a computer body 20. The battery 10 is a smart battery with a dummy function and includes a connector 11 to be connected to the computer body 20, a battery cell 12 for supplying power, a first user selecting part 13, a first memory 14 and a battery controller 15. The connector 11 includes a power input/output terminal for supplying and receiving power of the battery 10 and power of an adapter 30 from the computer body 20 (related to the thin line shown), and a data input/output terminal for communication between the battery 10 and the computer body 20 (related to the crossed hatched arrow shown).

The first user selecting part 13 serves to set and release the dummy function of the battery 10. The first user selecting part 13 may be provided with buttons or keys to select or release the dummy function. The first user selecting part 13 may be used to set other functions as well. Moreover, the battery cell 12 can be more than one cell, and can be any rechargeable battery type, such as lithium ion. Additionally, the selection can be input via the computer 20 such that the first user selecting part 13 need not be used in all aspects of the present invention.

In addition, the first memory 14 stores information on set and release of the dummy function of the battery 10. The first memory 14 may be implemented as a register or a flash memory. For example, if a register is used and if a dummy mode is set, a value of the register may be set to “1”. If a normal mode is set, a value of the register may be set to “0”. When one of the dummy mode and the normal mode is selected through the first user selecting part 13, the battery controller 15 stores information on the selected mode in the first memory 14 and transmits the information to the computer body 20 when the computer body 20 requests the information. The battery controller 15 may be implemented by a microcontroller. Accordingly, if the dummy mode is selected, a register value of the first memory 14 is set to “1”. If the normal mode is selected, a register value of the first memory 14 is set to “0”. Then, the register value set (or stored) in the first memory 14 is transmitted to the computer body 20. On the other hand, the battery controller 15 may receive a mode setting control signal related to the dummy function of the battery 10 from the computer body 20 and use the received mode setting control signal to set the register value in the first memory 14. The battery controller 15 may communicate with the computer body 20 via an interface such as a system management (SM) bus, which may be the implementation of the data input/output terminal discussed above. It is to be understood that such communication may be achieved via interfaces other than the SM bus, such as serial buses.

The computer body 20 shown in FIG. 1 includes a connector 21, a system part 22, a power supply 23, a battery charging part 24, a second user selecting part 25, a second memory 26 and a computer body controller 27. The system part 22 includes various electronic components, such as a CPU, a processor chip, and so on, and operates by power supplied from the adapter 30 or the battery 10. The power supply 23, which is connected to the adapter 30 or the battery 10, selects a power path through which power is supplied from the adapter 30 or the battery 10 under the control of the computer body controller 27, and outputs the power supplied from the adapter 30 or the battery 10 as power (for example, 12V, 5V, 3.3V, 2.7V, 2.5V, etc.) required for various components of the system part 22, such as the CPU, a mother board, a display, a hard disk drive, a CD ROM drive, etc. When the battery 10 is charged under the control of the computer body controller 27, the battery charging part 24 supplies a charging current and a charging voltage to the battery 10. The second user selecting part 25 serves to set and release the dummy function of the battery 10 and may be provided with buttons, keys, a mouse, a keyboard, a remote controller, etc. to select the dummy function. The second user setting part 25 may be used to select any functions of the battery 10 or the computer body 20. The computer body controller 27 controls the battery charging part 24 based on battery mode information set in the first memory 14 and the second memory 26 and may be implemented by a microcontroller and/or BIOS. More specifically, when one of the dummy mode and the normal mode is selected through the second user selecting part 25, the computer body controller 27 stores information on the selected mode in the second memory 26. For example, if the dummy mode is selected, a register value of the second memory 26 is set to “1”, and, if the normal mode is selected, a register value of the second memory 26 is set to “0”. The computer body controller 27 communicates with the battery controller 15 to confirm the mode information related to the dummy function of the battery 10, and accordingly, determines whether or not the battery charging part 24 charges the battery 10.

In addition, the computer body controller 27 may transmit a control signal to set the mode information related to the dummy function of the battery 10 to the battery controller 15, and accordingly, control the battery controller 15 to set a relevant mode (dummy mode or normal mode) in the first memory 14. Detailed operation of the computer body controller 27 will be described below.

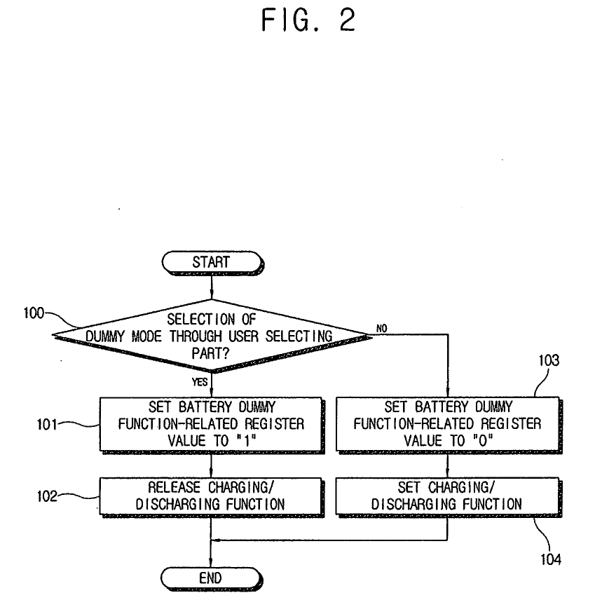

FIG. 2 is a control flow chart of the portable computer according to an aspect of the present invention. When the set or the release of the dummy mode is selected through the first user selecting part 13, a corresponding key select signal is input to the battery controller 15 at operation 100. If the dummy mode is selected (yes in operation 100), the battery controller 15 sets a register value of the first memory 14 to “1” at operation 101 and releases a charging/discharging function at operation 102. In addition, if the dummy mode is released (no in operation 100), that is, the normal mode is selected, the battery controller 15 sets a register value of the first memory 14 to “0” at operation 103 and sets a charging/discharging function at operation 104.

Similarly, in the computer body 20, as described above, when one of the set (yes) and the release (no) of the dummy mode is selected through the second user selecting part 25 at operation 100, the computer body controller 27 sets the correct information on the selected mode in the second memory 26 at operations 101 and 103, respectively. Then the corresponding subsequent release charging/discharging function at operation 102, or the set charging/discharging function at operation 104 is performed.

Then, when the battery controller 15 receives a signal requesting the mode information from the computer body 20, the battery controller 15 transmits the mode information set in the first memory 14 to the computer body 20. Upon receiving the mode information, the computer body controller 27 of the computer body 20 compares the received mode information with the mode information set in the second memory 26. If either of the first memory or the second memory 14 and 26 is set to the dummy mode, the computer body controller 27 sets a register value related to the dummy mode to “1” in the first memory 14 and the second memory 26 at operation 101 and releases the charging/discharging function at operation 102.

On the other hand, the release of the dummy mode is set in both of the first memory 14 and the second memory 26, the computer body controller 27 sets the charging/discharging function at operation 104. Thus, by adding the dummy function to the battery 10 and allowing a user to select the dummy function, deterioration of performance and reduction of durability of the battery 10 can be prevented by preventing charging of the cell 12 when the dummy function is selected.

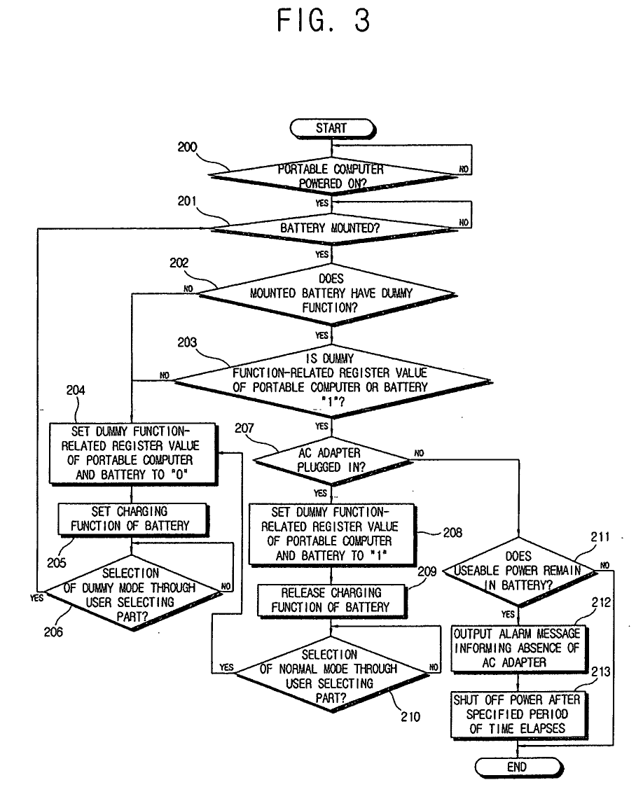

FIG. 3 is a control flow chart of a portable computer according to an aspect of the present invention. The chart will be described with reference to FIG. 1. In the following description, the same elements and operation as the first aspect will be omitted for the sake of brevity of explanation. When the portable computer is powered on at operation 200, the computer body 20 determines whether or not the battery 10 is mounted in the computer body 20 at operation 201. If it is determined that the battery 10 is mounted in the computer body 20 (yes in operation 201), the computer body controller 27 determined whether or not the battery 10 has the dummy function at operation 202. If it is determined that the battery has no dummy function (no in operation 202), the computer body controller 27 sets a dummy-related register value of the second memory 26 of the portable computer to “0” at operation 204. The remainder of the operations is discussed below.

If it is determined that the battery has the dummy function (yes in operation 202), the computer body controller 27 confirms a battery dummy function-related register value of the first memory 14 or the second memory 26 at operation 203. The register value set in the second memory 26 may be confirmed directly in the computer body, and the register value set in the first memory 14 of the battery 10 can be confirmed when the computer body controller 27 requests the battery 10 to provide the mode information related to the dummy function and the battery controller 15 transmits the mode information set in the first memory 14 to the computer body controller 27.

Based on the mode information set in the first memory 14 provided from the battery controller 15 and the battery dummy function-related register value of the second memory 26, if both of the dummy function-relate register values are set to “0” (i.e., setting of the normal mode (no in operation 203)), the computer body controller 27 maintains the values “0” at operation 204. Then, the computer body controller 27 sets the charging/discharging function to charge the battery 10 at operation 205.

Next, it is determined at operation 206 whether or not the dummy mode is selected through the first user selecting part 13 or the second user selecting part 25 during release of the dummy mode (that is, operation of the normal mode). If it is determined that the dummy mode is selected (yes in operation 206), the above-described processes are again performed, such as the determination about whether or not the battery is mounted in the computer body 20 at operation 201.

On the other hand, if at least one of the register values of the first memory 14 and the second memory 26 is “1” (yes in operation 203), the computer body controller 27 determines that the dummy mode is set and determines at operation 207 whether or not an AC adapter 30 is plugged in.

If the dummy mode is set and the AC adapter 30 is plugged in (yes in operation 207), the computer body controller 27 controls both of the first memory 14 and the second memory 26 to set the dummy function-related register values to “1” at operation 208. Then, the computer body controller 27 releases the charging function of the battery charging part 24 at operation 209.

In addition, during operation of the dummy mode, if the dummy mode is released (that is, the normal mode is selected) through the first user selecting part 13 or the second user selecting part 25 at operation 210, the computer body controller 27 sets the dummy function-related register values of the second memory 26 and the first memory 14 of the battery 10 to “0” and then allows the battery to be charged at operations 204 and 205.

On the other hand, if the dummy mode is set but the AC adapter 30 is not plugged in (no in operation 207), the computer body controller 27 determines at operation 211 whether usable power remains in the battery 10 (yes in operation 211). If the power remains in the battery 10, the computer body controller 27 outputs an alarm message indicating the absence of the AC adapter 30 at operation 212 and shuts off the power after a specified period of time elapses at operation 213. If no power remains (no in operation 211), the power is shut off.

Accordingly, by controlling the charging function of the battery 10 depending on the dummy mode or the normal mode set in the battery 10 or the computer body 20, the problem of reduction of durability and deterioration of performance of the battery 10 can be managed.

Although it is illustrated in the aspects of the present invention that the first user selecting part 13 and the first memory 14 are provided in the battery 10 and the second user selecting part 25 and the second memory 26 are provided in the computer body 20, these user selecting parts 13, 25 and memories 14, 26 may be provided in only one of the battery 10 and the computer body 20. In addition, although it is illustrated in the above aspects that the registers are exemplified as the first memory 14 and the second memory 26 as dummy function-related information storages, other forms of data storages may be used as the memories, such as flash ROMs and/or non-volatile memories.

In addition, although it is illustrated in the above aspects that the dummy mode is set in one of the computer body 20 and the battery 10, the dummy mode may be set in both of the computer body 20 and the battery 10.

As apparent from the description, aspects of the present invention provide a battery pack having a dummy battery function for reducing deterioration of performance of a battery and reduction of durability of the battery, a portable computer and a control method thereof. While not required in all aspects, it is understood that all or portions of the invention can be implemented as software encoded on one or more computer readable media for use with one or more computers/processors.

Although a few aspects of the present invention have been shown and described, it will be appreciated by those skilled in the art that changes may be made in these aspects without departing from the principles and spirit of the invention, the scope of which is defined in the appended claims and their equivalents.

What is claimed is:

1. A portable electronic apparatus, comprising:
a system body comprising a plurality of components:
a battery to supply power to the system body;
a battery charging part to charge the battery with power externally supplied;
a user selecting part selectable between a dummy mode and a normal mode related to the battery; and
a controller to control the battery charging part to not charge the battery when the dummy mode is selected through the user selecting part and control the battery charging part to charge the battery when the normal mode is selected through the user selecting part.

2. The portable electronic apparatus according to claim 1, further comprising a memory in which mode information related to the dummy mode and the normal mode is set, wherein the controller sets the mode information based upon the mode selected through the user selecting part in the memory.

3. The portable electronic apparatus according to claim 2, wherein the controller controls the battery charging part to charge the battery based on the mode information set in the memory.

4. The portable electronic apparatus according to claim 1, wherein
the user selecting part is provided in the battery, and the controller comprises a battery controller provided in the battery to provide the mode information corresponding to the selection of the user selecting part to the system body, and a body controller to control the battery charging part to charge the battery based on the mode information provided from the battery controller.

5. The portable electronic apparatus according to claim 4, wherein
the battery comprises a memory in which information related to the dummy mode and the normal mode is stored, and
the battery controller stores the mode information on the mode selected through the user selecting part in the memory.

6. The portable electronic apparatus according to claim 5, wherein the battery controller communicates with the body controller via a system management (SM) bus.

7. The portable electronic apparatus according to claim 2, wherein the user selecting part comprises a first user selecting part provided in the battery and a second user selecting part provided in the system body.

8. The portable electronic apparatus according to claim 7, wherein
the memory comprises a first memory in which first mode information corresponding to selection of the first user selecting part is stored and the system body comprises a second memory in which second mode information corresponding to selection of the second user selecting part is stored, and the controller comprises a battery controller provided in the battery to store the first mode information in the first memory, and a body controller to store the second mode information in the second memory.

9. The portable electronic apparatus according to claim 8, wherein
the battery controller provides the first mode information to the system body, and the body controller controls the battery charging part to charge the battery based on the first mode information provided from the battery controller and the second mode information from the second memory.

10. The portable electronic apparatus according to claim 9, wherein the body controller controls the battery charging part to not charge the battery when at least one of the first mode information and the second mode information is related to the dummy mode.

11. A battery pack mounted in an electronic apparatus to supply power to the electronic apparatus, comprising:
a battery;
a user selecting part selectable between a dummy mode and a normal mode related to the battery;
a memory in which mode information related to the dummy mode and the normal mode is stored; and
a battery controller to set the mode information on the mode selected through the user selecting part in the memory and transmit the set mode information to the electronic apparatus.

12. A control method of a portable electronic apparatus having a system body having a plurality of components, a battery to supply power to the system body, a battery charging part to charge the battery with power externally supplied, and a user selecting part, the method comprising:
selecting one of a dummy mode and a normal mode related to the battery through the user selecting part, the user selecting part allowing a selection selectable between dummy and normal modes; and
controlling the battery charging part to not charge the battery when the dummy mode is selected through the user selecting part, and controlling the battery charging part to charge the battery when the normal mode is selected through the user selecting part.

13. The control method according to claim 12, wherein the controlling the battery charging part comprises setting mode information based upon the mode selected through the user selecting part in a predetermined memory and controlling the battery charging part to charge the battery or not charge the battery based on the mode information set in the memory.

14. The control method according to claim 12, wherein
the user selecting part is provided in the battery, and the controlling the battery charging part comprises providing mode information corresponding to selection of the user selecting part to the system body and controlling the battery charging part to charge the battery or not charge the battery based on the mode information.

15. The control method according to claim 14, wherein the battery further comprises a memory in which the mode information related to the dummy mode and the normal mode is set, and the providing the mode information corresponding to selection of the user selecting part to the system body comprises setting the mode information in the memory in correspondence with selection of the user selecting part and transmitting the mode information set in the memory to the system body.

16. The control method according to claim 13, wherein the user selecting part comprises a first user selecting part provided in the battery and a second user selecting part provided in the system body, the memory comprises a first memory in which first mode information corresponding to selection of the first user selecting part is stored and the system body comprises a second memory in which second mode information corresponding to selection of the second user selecting part is stored, and the controlling the battery charging part comprises storing the first mode information in the first memory, storing the second mode information in the second memory, providing the first mode information to the system body, and controlling the battery charging part to charge the battery or not charge the battery based on the first mode information and the second mode information.

17. The control method according to claim 16, wherein the controlling the battery charging part to charge the battery or not charge the battery comprises controlling the battery charging part to release charging of the battery when at least one of the first mode information and the second mode information is related to the dummy mode.

18. A portable device, comprising:
a battery having a first selector; and
a main body having a second selector and a controller, wherein the controller disables the battery to prevent charging when either of the first or second selectors is set to a disable mode.

19. The portable device of claim 18, wherein the controller enables the battery to allow charging when both of the first and second selectors are set to an enable mode.

20. A method of controlling a portable device having a battery having a first selector and a main body having a second selector, comprising disabling a charging of the battery when either of the first or second selectors is set to a disable mode.

21. The method of claim 20, further comprising enabling the battery to allow charging when both of the first and second selectors are set to an enable mode.

22. A battery pack for a portable device, comprising:
a cell to supply power;
a controller to control charging of the cell according to selection states selectable between a dummy mode and a normal mode; and
a memory storing the selection states used by the controller.

23. The battery pack of claim 22, wherein the cell is not charged in the dummy mode.
